(19) United States
(12) Patent Application Publication
(10) Pub. No.: US 2001/0002963 A1
(43) Pub. Date: Jun. 7, 2001

(54) Thread and screw connection for high application temperatures

(76) Inventors: Detlef Haje, Bottrop (DE); Kai Wieghardt, Bochum (DE)

Correspondence Address: OLIFF & BERRIDGE, PLC, P.O. BOX 19928, ALXANDRIA, VA, 22320, US

(21) Appl. No.: 09/748,809

(22) Filed: Dec. 26, 2000

(30) Foreign Application Priority Data
Jun. 26, 1998 (DE) 198 28 453.5

(51) Int. Cl. F16D 1/00; F16B 1/00; F16C 9/00; F16G 11/00

(52) U.S. Cl. 403/30

(57) ABSTRACT

The thread of a first component extends along a thread axis and has a thread structure for meshing engagement into a counterthread of a second component having a counterthread structure, for making a screw connection. The elastic and/or thermal deformation behavior of the first component and of the second component are different from one another. The thread structure is configured with an anticipation of deformation, in order to compensate for an elastic and/or thermal deformation under a predeterminable thermomechanical load, and a cylindrical thread segment of constant diameter. There is provided a thread segment, axially adjacent to the cylindrical thread segment, with a diameter that varies along the thread axis. The thread assembly is utilized in a screw connection for a high application temperatures.

### BACKGROUND OF THE INVENTION

Field of the Invention

The invention lies in the mechanical arts and relates, more specifically, to a thread which extends along a thread axis, with a thread structure for engagement into a counterthread with a counterthread structure for making a screw connection. The invention relates, furthermore, to a screw connection for high application temperatures, i.e., to assembly structures with screw connections to be exposed to high temperatures.

Screw connections consisting of a screw with a bolt thread and with a counterthread (nut thread) are employed in a multiplicity of technical areas, such as mechanical engineering, plant construction, and electrical engineering. They serve, as a rule, for connecting and fastening two parts to one another. There exist, in one extreme, small screw connections which are used at room temperature and need to transmit low forces and, in the other extreme, large screw connections which have to transmit high forces at high temperatures.

The publication “Schraubenvademecum” [“Screw manual”] by Illgner and Blume, 1976, Fa. Bauer & Schaurte Karcher, Neuss, Germany, in particular section 3.5, discloses that, under elastic deformations of threads of a screw connection, different notch fatigue factors prevail at different notch points and influence the fatigue strength. The initial region, in which the thread and counterthread engage one into the other in the loading direction determines the fatigue strength. In order to reduce the super-proportionally high loads occurring in this initial region, while retaining the same thread structure of the thread and counterthread, the shape of the nut thread can be changed. In this change of shape, the outside diameter of the nut body is smallest in the initial region and increases monotonically opposite to the loading direction (tension nut, nut screwed in annularly). Other methods for relieving the initial region involve providing an overlapping nut thread, a countersinking of the nut thread and relief notches in the initial region.

A thread connection between parts having different linear thermal expansion coefficients may be gathered from European patent EP 0 008 766 B1. In order to minimize stresses in the threaded connection and use the threaded connection at increased working temperatures a taper is provided at ambient temperature. In this case, the taper is produced by means of a linear change in the radial play along the thread axis, radial play increasing in the direction of the loading of the part with the higher linear thermal expansion coefficient. This conical design of the taper over the entire length of the threaded part makes it possible to have a reliable tensioning of the threaded connection in the hot state only. By contrast, in the cold state, that is to say at ambient temperature, there is no efficient transmission of the screw force to the threaded connection and reliable absorption of the prestressing force.

U.S. Pat. No. 2,770,997 describes a cylindrical screw connection with a nut thread and with a bolt thread which is in engagement with a nut thread. The material of the nut thread and of the bolt thread have, in this case, different thermal expansion coefficients, for example a ceramic material for the nut thread and a material with a higher thermal expansion coefficient, a metal, for the bolt thread. In order to make it possible for the ceramic/metal screw connection to be used over a wide temperature range of about 20° C. to 900° C., an adaptation of the thread rise angle of the nut thread and bolt thread is provided in the cylindrical screw connection along the cylinder axis, so that maladaptions at high temperatures can be partially compensated.

For this purpose, the thread lead and rise angle of the nut thread and bolt thread is configured in such a way that an adaption of the thread rise occurs at an upper temperature limit.

### SUMMARY OF THE INVENTION

The object of the present invention is to provide a thread and screw connection which overcomes the above-noted deficiencies and disadvantages of the prior art devices and methods of this general kind, and wherein the thread, which extends along a thread axis, for a component, is provided with an essentially homogenous load distribution along the thread axis. Another object of the invention is to specify a screw connection for high application temperatures.

With the above and other objects in view there is provided, in accordance with the invention, a thread assembly for making a screw connection between a first component and a second component having mutually different elastic and/or thermal deformation behavior, comprising:

a thread, extending along a thread axis, formed in a first component with a thread structure for engagement into a counterthread of a second component formed with a counterthread structure;

the thread having a cylindrical thread segment of constant diameter; and

a further thread segment, axially adjacent the cylindrical thread segment, the further thread segment having a diameter varying along the thread axis for compensating for an anticipated elastic and/or thermal deformation under a predetermined thermomechanical load.

In other words, the above and othere objects directed at a thread are satisfied with a thread of a first component, the thread extending along a thread axis, with a thread structure for engagement into a counterthread of a second component with a counterthread structure for making a screw connection, the elastic and/or thermal deformation behavior of the first component and of the second component being different from one another, the thread structure having an anticipation of deformation, in order to compensate elastic and/or thermal deformation under a elastic and/or thermal deformation under a predeterminable thermomechanical load, and a cylindrical thread segment of constant diameter, a further thread segment being provided, which adjoins the cylindrical thread segment axially, the diameter varying along the thread axis in the further thread segment.

The different deformation behavior may, in this case, be brought about by a different rigidity of the components, for example even with regard to essentially identical materials of the components with the same modulus of elasticity, and even when the components are in the cold state. The first component has a first material in the vicinity of the thread and the second component has a second material in the vicinity of the counterthread. The two materials may possess identical, similar or markedly different elastic, plastic and/or thermal material properties. The materials are preferably materials with a different chemical composition or alloys with at least different material properties. However, alloys with an identical material composition or identical material properties may also be used.

By means of the thread according to the invention, there is, for the first time, a controlled anticipation of deformation, as compared with the previous practice of achieving merely a reduction in the expected stress excesses by matching the rigidity of a nut to the rigidity of a screw. Simultaneously, for the first time, reliable force transmission and load absorption by the thread, even in the undeformed state, that is to say in the mounting state at room temperature, are ensured.

Where thermal deformation is concerned, the invention proceeds, here, from the recognition that, for screw connections at high temperatures, considerable requirements are placed on the screw materials used. Above particular temperature limits, for example above 500° C., in particular 580° C., in the case of steam turbines, screw materials based on iron can no longer or (because of insufficient strength) no longer appropriately be used. The screw materials which then come into consideration have different (substantially higher) thermal expansion coefficients from the high-temperature nut materials, for example flange materials, based on iron which are normally used at these temperatures. In the event of a temperature increase, differential thermal expansions in the thread segment cause the load to be shifted to the first thread segment (initial engagement region) which in any case is subjected to high load. This forestalls the use of screw materials of higher thermal expansion, since inadmissibly high stress values may thus occur. According to the invention, therefore, a deformation-compatible configuration of the thread is specified for the first time, so that the additional stress on the thread at high temperatures is prevented or at least reduced and, consequently, it also becomes possible for materials with a different thermal expansion behavior to be used for the thread and counterthread.

This is advantageous, in particular, in the case of use in steam turbines at steam temperatures of above 550° C., in particular above 580° C. At these high application temperatures, therefore, it is possible to dispense with material pairings of flange and screw-connection materials which are identical in terms of their thermal expansion behavior or the thermal expansion behavior of which is such that, in the event of a temperature increase, the stress on the thread is not concentrated inadmissibly at specific locations. To be precise, with an increase in temperature, it would be necessary to provide larger screw cross sections for such material pairings. This is limited, however, by the long-term strength of the materials, which decreases against the temperature, and by possible limits to the use of the materials, for example as a result of material-related effects which occur, such as long-period notch impact embrittlement. This disadvantage of identical materials is now eliminated by the possibility of using different materials.

At high temperatures and when high-temperature materials are used, for example in the case of 10%-chromium steels for flanges for nickel-based screws, for example made from Nimonic 80A, where conventional threads and counterthreads are concerned a thermal expansion difference arises which causes greater stress on the first thread segment (initial engagement region) as a result of a load shift. The consequence of this is that the bolt material has a higher thermal expansion than the flange material; starting from the first load-bearing thread flank of a screw connection, this brings about an elongation of the bolt thread relative to the nut thread. This leads to a relief of the following flanks and, under some circumstances, to a disengagement of flanks lying further in the screw connection, due to the thermally induced pitch errors, and therefore to additional load on the first thread segment (initial engagement region). Under some circumstances, this could necessitate a marked reduction in load and be detrimental to the operating reliability of the screw connection as a whole. This problem, too, is solved by the thread's anticipation of deformation which takes into the account the differential thermal expansion according to the invention, so that the initial engagement region is reliably subjected to a lower load than a permissible critical load up to the application temperature and higher temperatures.

The thread of the screw connection has, in this case, a deformation-compatible configuration such that, at the application temperature, a favorable load-bearing behavior generated by virtue of thermal deformation itself is established as a result of thermal expansion. In this case, the thermal thread deformation is compensated at the outset. The thread is manufactured in such a way that there are, as compared with the conventional thread, controlled deviations, for example in thread shape, amount of taper, pitch or thread profile, which are compensated completely or partially by the thermal expansion at the intended application temperature. A more uniform distribution of the load-bearing behavior is thus established as a result of the different thermal expansions.

It is possible in a simple way, for the outset, to take into account the thermal expansion for each application temperature and application load (force transmission) and for each counterthread analytically or via commercially obtainable computing programs, for example based on the Finite-Element Method (FEM), the Boundary Element Method (BEM) or the Finite Difference Methods. In this context, to design the thread, the computing methods can make use of the known thermomechanical material equations, in which the different moduli of elasticity and thermal expansion coefficients are taken into account. The manufacture of the thread with the thread shape may, particularly for cut bolt threads, be carried out in a simple way by means of numerically controlled machine tools.

It goes without saying, therefore, that the anticipation of deformation according to the invention can be used, even in the case of purely elastic and elastoplastic deformations, at an essentially constant temperature. Thus, even in the case of pure elastic or elastoplastic deformations, there is an improvement in the fatigue strength of the initial engagement region which is critical for the fatigue strength of the entire screw connection. Depending on the embodiment, an improvement in this initial engagement region up to a factor of two may be achieved, so that another region of the screw is critical for the fatigue strength of the screw connection. The thread is therefore also suitable in broad areas of conventional screw technology in the case of relatively small or simply designed screw connections in which there is merely a different elastic deformation behavior of the thread and counterthread of the components screwed together. Anticipation of deformation with regard to thermal and elastic or elastoplastic deformations may, of course, also be taken into account.

In the cold state, that is to say at normal temperature, the thread, by virtue of the geometry which takes into account the change of shape, has a load-bearing behavior which differs from a conventional thread and may also be concentrated on a few thread flights. This is acceptable, inter alia, because the load-bearing capacity of the screw and flange materials is substantially higher in the cold state than at high application temperatures. Moreover, in application in a steam turbine, the maximum stress on the screw connections, occurs, as a rule, in the case of screwed-together pressure-carrying parts (for example, turbine casing, screwed-together covers), only under the full action of pressure. In a steam turbine, this full action takes place, by virtue of the principle adopted, at increased temperature, for which the thread geometry is deliberately improved.

Measures may nevertheless also be taken, which reduce the effect of the higher stresses in the cold state in a controlled way. Preferably, in this case, one thread segment is designed as a normal thread, by means of which the screw force is borne reliably in the cold state. In the event of a temperature increase, this thread segment is relieved by other deformation-anticipating thread segments. As a result of this design, an equalization of the load-bearing behavior of the thread over an extended temperature range, that is to say, for example from room temperature up to the application temperature, is achieved.

In accordance with a further preferred embodiment, the thread has, along the thread axis, a diameter which varies at least in regions, in particular increases monotonically. In this case, the thread structure may have a curved design, at least in one thread segment, a tangent to an enveloping curve of the thread forming an acute angle with a line parallel to the thread axis. This angle decreases continuously, in particular monotonically. It may approach zero. The thread structure may at the same time, at least in one thread segment, also have a tapered design with a taper angle which is acute in relation to the thread axis. Such a taper angle amounts, preferably, to between 0.1° and 1.0°, in particular to about 0.3°. The tapered thread segment is followed, preferably opposite to a loading direction, that is to say in the direction away from the initial engagement region, by the cylindrical thread segment of constant diameter.

In this case, preferably, a controlled withdrawal of the first thread flight radially out of the thread takes place (the diameter of the external thread reduced at the thread start or the diameter of the internal thread increased in this region). The radial withdrawal of the flanks from the thread teeth which is caused thereby gives rise to play between two adjacent flanks of the thread and the counterthread in the first thread segment (initial engagement region). In the case of an undeformed (ideal) thread, the thread teeth configured in this way do not come into engagement; when the screws are tensioned, the flanks can come into contact again, but this is not mandatory. As a result, even in the event of purely elastic deformations, an equalization of the loads in the thread along the thread axis is achieved. With a corresponding embodiment of the thread, in the case of thermal and/or elastic deformation, the thread teeth come into engagement and assume part of the screw force. The flanks within the screw connection which are subjected to higher load due to the changed shape are therefore relieved, as compared with the cold state. In this case, the thread stress on the first thread segment does not attain the value which would occur in the case of normal thread configuration.

The effects of thermal expansion can be compensated effectively by a suitable choice of the taper angle or by another suitable variation in diameter. The tapered thread segment may have different leads and be combined with cylindrical thread segments, in order, for example, to achieve a better load-bearing behavior in the cold state. Furthermore, additional compensation of the high stress on the first thread flight which occurs with normal threads (and which is due to elastic deformation) can be achieved as a result. A preferred taper angle for thermal compensation at an application temperature of about 600° C. in the case of a 10%-chromium-steel for a nut thread and a nickel-based alloy, for example Nimonic 80A, for a bolt thread (600° C.) amounts to approximately 0.3°. The taper angle is, in this case, selected preferably in such a way that the first thread segment (initial engagement region) comes into engagement and comes to bear at the application temperature.

As compared with tapered threads, which serve for achieving a sealing effect in the thread or as an unscrewing safeguard by radial clamping and in which, for this purpose, either two tapered threads of the same taper angle are paired or one tapered thread is paired with one cylindrical thread, in such a way that the thread play decreases with progressive screwing-in, in the above tapered thread the thread play in relation to the first thread teeth is greater, in order to relieve these in a controlled way in the operating state.

In accordance with another preferred embodiment, the thread has at least one thread segment with a pitch which changes along the thread axis. Also preferably, the thread segment with a changing pitch is followed opposite to the loading direction by a thread segment with constant pitch.

Preferably, a controlled introduction of a pitch deviation between the thread and the counterthread is carried out, in order to compensate the pitch deviation occurring as a result as thermal and/or elastoplastic expansion. In this case, the pitch of a bolt thread is smaller than that of the associated nut thread which has a lower thermal expansion coefficient. At the application temperature, an equalization of the pitch is established due to the greater thermal expansion of the bolt. The pitch may vary over the thread length. Preferably, a thread segment without pitch deviation is provided for a favorable behavior in the cold state and a thread segment with increased pitch deviation at the thread start is provided for compensating the additional load on the first thread segment. The mountability and demountability of the bolt may, in this case, be ensured, for example, by applying a temperature difference between the bolt thread and nut thread, for example a heating of the bolt before screwing-in, or by the provision of correspondingly increased flank plays.

In a further embodiment, the thread has a thread segment with a changing thread profile. For this purpose, the flank angle of a flank may change along the thread axis. The change may take place monotonically or in steps, in the latter case two regions, each with a constant but different thread profile, adjoining one another. It is also possible for the falling flank and the rising flank of a thread tooth to have a flank angle which is different in each case. Preferably, the thread segment with a changing thread profile is followed by an, in particular, cylindrical thread segment with a constant thread profile.

The rigidity and the engagement of the individual flanks can be influenced by an adaptation of the thread profile. Thus, for example, changes to the flank angle, different part flank angles or other geometrical changes to the thread teeth are possible.

It is also possible for a thread to contain a combination of individual or all the measures for the anticipation of deformation, such as change of pitch, change of thread profile and diameter configuration. They may be carried out in each case on one thread of a screw-connection partner (bolt thread or nut thread) or on both.

Preferably, the thread is designed for use at an application temperature of above 500° C., in particular above 580° C.

It is preferably a bolt thread on a screw composed of an nickel-based alloy. For a component, a cobalt-based alloy or an austenitic steel may be provided, as an alternative to a nickel-based alloy, at least in the vicinity of the thread or of the counterthread.

The object directed at a screw connection is achieved by means of a screw connection for a high application temperature, with a thread, in which, when the thread and the counterthread engage one into the other at a normal temperature below the application temperature, play remains, in an initial engagement region, between the thread structure of the thread and the counterthread structure of the counterthread or there is, at least, a relief of the flanks which are in contact. The screw connection is preferably made on a flange of a steam turbine. The flange consists preferably of a chromium steel with a fraction of 9% by weight to 12% by weight of chromium.

Other features which are considered as characteristic for the invention are set forth in the appended claims.

Although the invention is illustrated and described herein as embodied in a thread and screw connection for a high application temperature, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a longitudinal section through a screw connection with a bolt screwed into a flange;

FIGS. 2A, 3A, 4A, 5A are sectional details of a screw connection similar to that of FIG. 1 in the cold state; and

FIGS. 2B, 3B, 4B and 5B are sectional views each showing the corresponding detail at a high application temperature.

Identical and functionally equivalent parts are identified with the same reference symbols throughout the figures.

### DESCRIPTION OF THE PREFERRED EMBODIMENTS

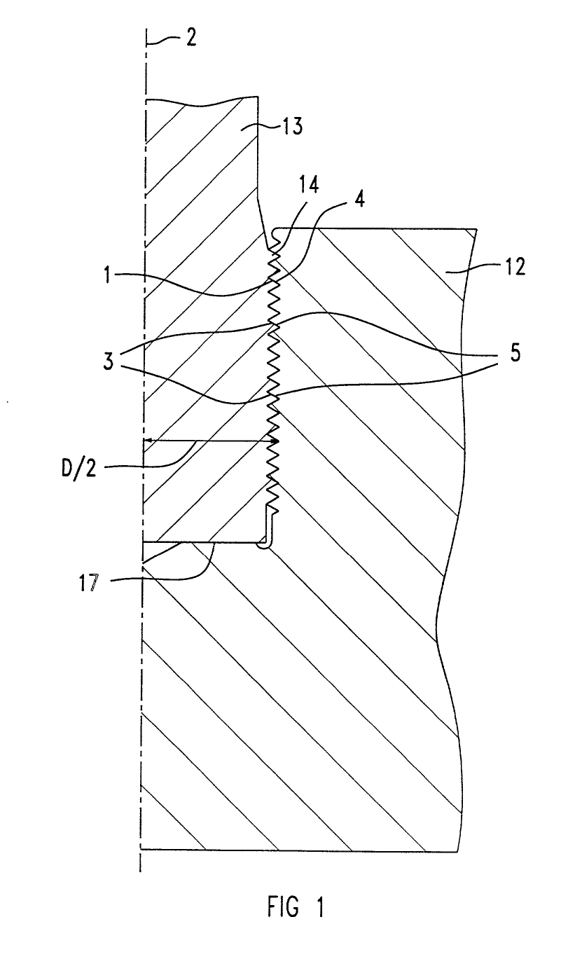

Referring now to the figures of the drawing in detail and first, particularly, to FIG. 1 thereof, there is seen a longitudinal section through a screw connection in a flange 12 of a steam turbine. The latter is referenced as an example only and is, therefore, not illustrated. The flange 12 has a counterthread 4 designed as a nut thread.

A bolt or screw 13 extending along a screw axis 2 is screwed into the counterthread 4 (nut thread 4). The screw 13 has a thread 1 which is designed as a bolt thread and which meshes with the nut thread 4. The bolt thread 1 has a thread structure 3 and the nut thread 4 a counterthread structure 5. By virtue of the rotational symmetry of the screw 13 with respect to the screw axis 2, only half of the longitudinal section through the screw 13 is illustrated. The screw 13 has an end face 17 which is perpendicular to the screw axis 2 and with which the screw 13 is screwed farthest into the flange 12. The region, starting from which the screw 13 projects from the nut thread 4 of the flange 12, is designated as the initial engagement region 14 of the thread 1 into the counterthread 4. In conventional threads, this region is the region which is critical for the fatigue strength of the screw connection.

The following numerical computation results were achieved for a screw connection illustrated in FIG. 1, with a M120x6 setscrew 13 under an assumed shank tension of 250 N/mm² at a temperature of 600° C. In these computations, the thermal expansion behavior of a 10%-chromium steel (X12CrMoWVNbN10-1-1) was assumed for the flange 12. This steel has a mean thermal expansion coefficient of 12.7·10⁻⁶/K at a temperature of between 20° C. and 600° C. When an 11%-chromium steel (X19CrMoVNbN11-1) is used for the screw 13, local stress excesses are exhibited in the initial engagement region 14, but these do not impair the load-bearing behavior of the thread 1 at temperatures below the limit temperature of the high-temperature non-austenitic screw steel of about 560° C. These local stress excesses result from the different rigidities of the screw 13 and of the flange 12.

When a nickel-based material is used for the screw, for example Nimonic 80A, with a conventional thread, a pronounced stress excess is exhibited in the initial engagement region 14 as a result of the different thermal expansion coefficients. As shown by finite element computations, which include the plastic material behavior, this leads to pronounced plastic expansions in the flange 12 which may correspond to the breaking expansion of the flange material. Under thermal load changes, this could lead, under some circumstances, to a failure of the thread flights in the flange 12. The mean thermal expansion coefficient of Nimonic 80A is approximately 15·10⁻⁶/K at 600° C.

When a screw 13 made from the material Nimonic 80A is used, with a tapered design of the thread 1 (bolt thread 1) having a taper angle of about 0.3°, the result is, in the initial engagement region 14, a stress state which corresponds to the stress state when an 11%-chromium steel is used for the screw 13. In this case, a taper angle of about 0.3° corresponds, in the initial engagement region 14, to a reduction in diameter of about 0.6 mm. Further homogenization of the load-bearing behavior, that is to say relief of the initial engagement region 14, may take place by virtue of a slight increase in the taper angle in order to compensate the rigidity differences between the screw 13 and flange 12. In the case of the tapered design of the thread 1, increased loads arise in the further-in thread flights, that is to say in the region of the end face 17, at low temperatures of about 20° C. (mounting state), but these loads are not critical due to the higher load-bearing capacity of the screw material and of the flange material in the cold state. These increased loads may be reduced by a conventional cylindrical thread, preferably with a constant diameter D, being used in the region of the end face 17.

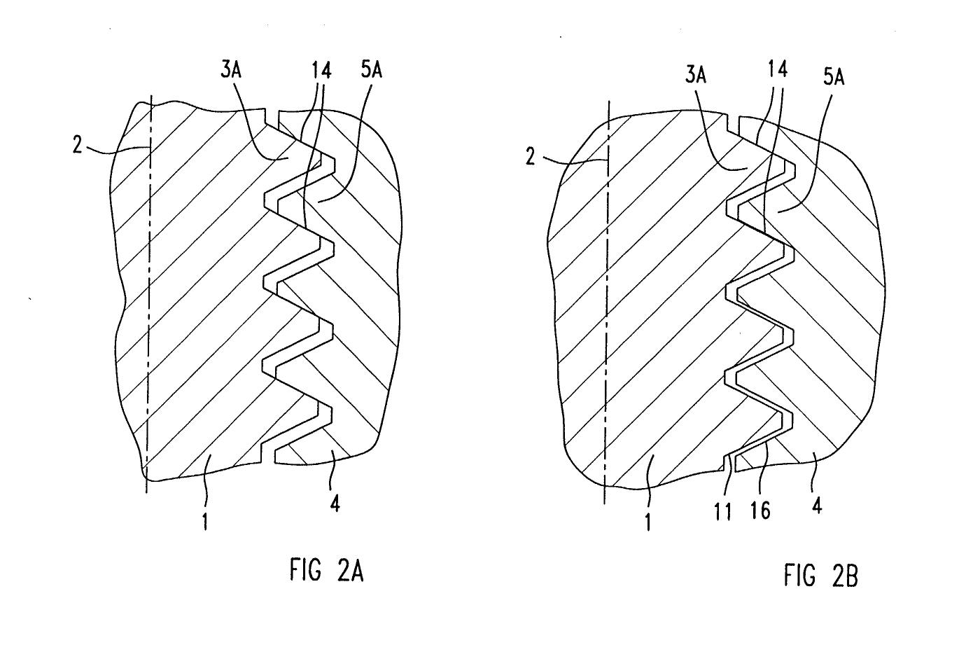

FIG. 2A shows a detail through a screw connection with a bolt thread 1 and with a nut thread 4 in the cold state in which the thread teeth 3A of the bolt thread 1 bear with a flank 11 on a respective flank 16 of an associated thread tooth 5A of the nut thread 4. The bolt thread 1 consists, in this case, of a material with a higher thermal expansion coefficient than the material of the nut thread 4. In the event of an increase in the temperature, for example to an application temperature of 600° C., the different thermal expansion of the screw 13 in relation to the flange 12 leads to the further-lying thread teeth 3A to lift off with their flanks 11 from the associated flanks 16 of the thread teeth 5A or at least to be relieved (see FIG. 2B). The result of this is that not all the thread teeth 3A and 5A are any longer load-bearing, but, instead, the load is shed virtually completely via the thread teeth 3A and 5A of the initial engagement region 14. This leads, at increased temperatures to an occasionally critical load on the initial engagement region 14. The screw connection is preferably prestressed even in the cold state.

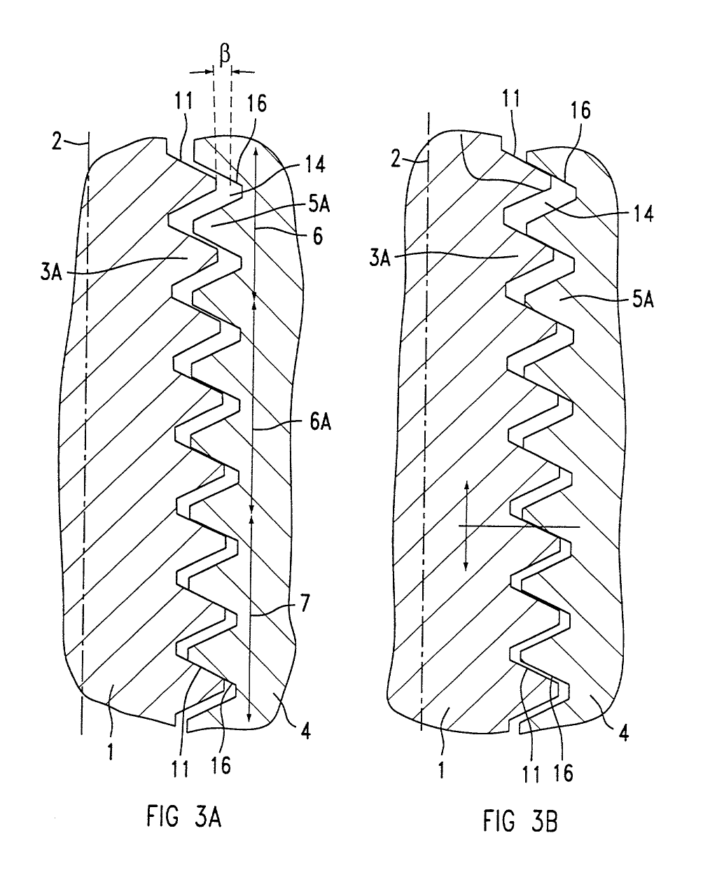

FIG. 3A illustrates a thread 1 with a variation in diameter, in engagement with a counterthread 4 (nut thread 4), in the cold state. The thread 1 has a cylindrical thread structure of constant diameter D in the thread segment 7 facing the end face 17. In the thread segment 7, those flanks 11 of the thread teeth 3A facing away from the end face 17 bear directly on the respective flanks 16 of the associated thread teeth 5A of the nut thread 4. In the vicinity of the initial engagement region 14, the thread 1 has a tapered thread segment 6, the taper angle β of which is dimensioned according to the expected thermal and elastic expansions at a predetermined application temperature of the thread 1. Between the thread segment 6 and the thread segment 7 is located a thread segment 6A, in which the thread 1 likewise has a tapered construction. In this case, the associated taper angle is dimensioned according to expected thermal expansions.

The variation in diameter D in the region of the tapered thread segments 6, 6A as illustrated has been greatly exaggerated for the sake of clarity. At an increased temperature, in particular the application temperature of the thread 1, different thermal expansions of the screw 13 (higher thermal expansion coefficient) and of the flange 12 (lower thermal expansion coefficient) take place. In the thread segment 6, the flanks 11 and 16 come into full engagement under elastic and thermal deformation (see FIG. 3B). In the thread segment 6A, the flanks 11 and 16 come into full engagement under thermal expansion. An equalization of the load-bearing behavior and, as a result, a partial or complete relief of the initial engagement region 14 are thereby achieved. At increased temperature, the flanks 11 and 16, which, in the cold state, are load-bearing in the thread segment 7, lift off from one another or are at least relieved.

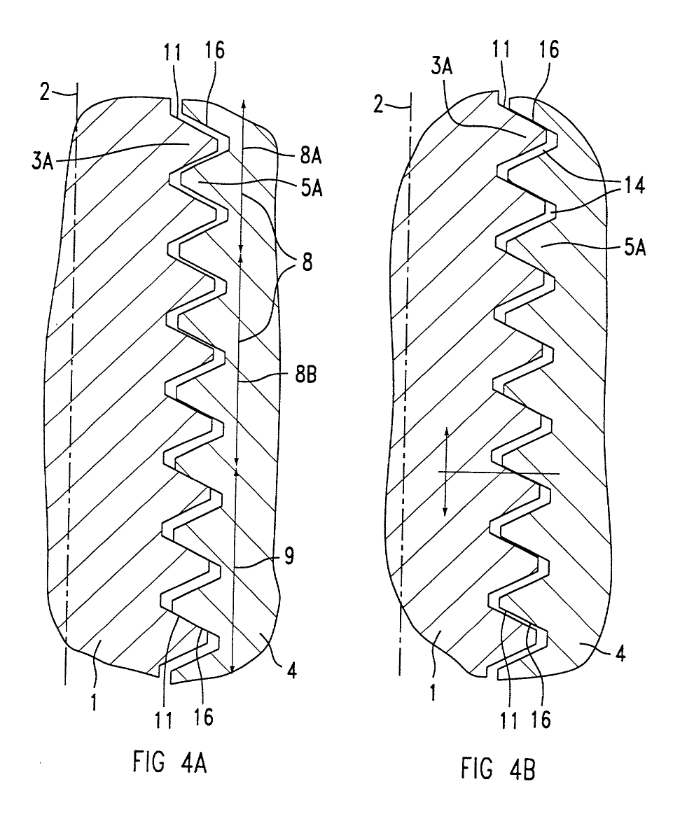

FIG. 4A illustrates a screw connection in which the thread 1 has a variation in pitch. In the initial engagement region 14, there is a thread segment 8A with a varied pitch which is determined according to expected thermal and elastic expansion. The thread segment 8A has adjoining it a thread segment 8B, the pitch of which is varied in light of an expected thermal expansion. The thread segments 8A and 8B form a thread segment 8 in which there is a varied pitch of the thread 1. The thread segment 8 is followed, toward the end face 17, by a thread segment 9 with a normal pitch, so that, in the cold state, the flanks 11 and 16 bear on one another and thereby shed a load determined by prestress. The flanks 11 and 16 in the thread segment 8 are at least (partially) relieved or even spaced from one another. The variation in pitch is likewise illustrated as being exaggerated for the sake of clarity. In the event of an increase in temperature, the effect, already described above, occurs (see FIG. 4B), whereby flanks 11, 16 in the thread segment 8 come into full engagement as the result of elastic and thermal or only thermal expansions and an equalized load-bearing behavior and a relief of the initial engagement region 14 are thus achieved. In the event of an increase in temperature, the flanks 11 and 16 in the thread segment 9 are relieved or even lift off from one another.

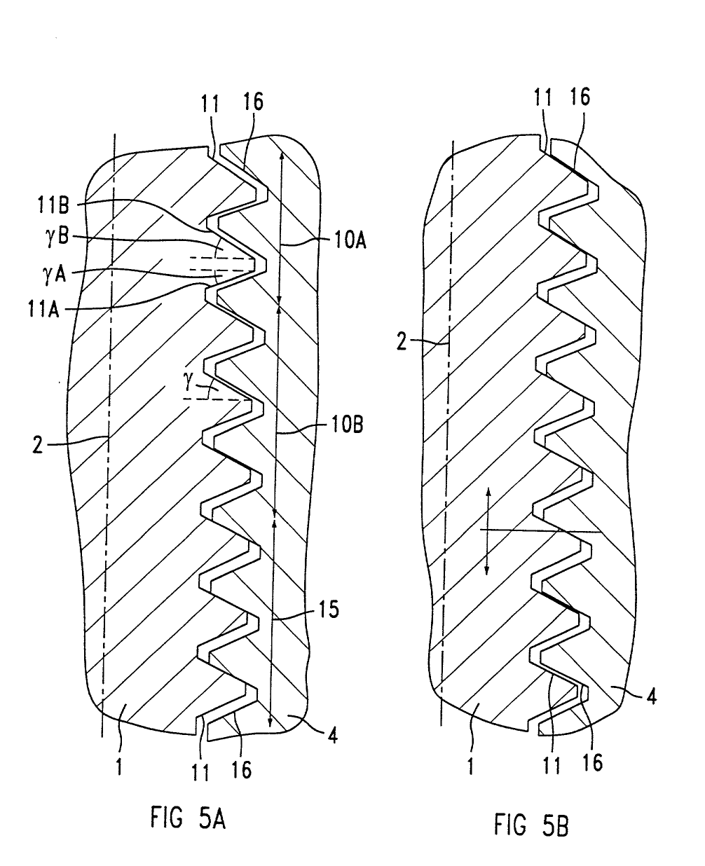

FIG. 5A illustrates a detail of thread 1 with a variation in the thread profile, the variation in the thread profile being achieved here, using an unequal part flank angle of the thread teeth 3A. The flanks 11B (rising flanks) facing away from the end face 17 have a flank angle γB which is larger than the flank angle γA of the flanks 11A (falling flanks) facing the end face 17. In a thread segment 15 which adjoins the end face 17, the thread profile of the thread 1 is selected conventionally, so that, under prestress in the elastic state, the flanks 11 and 16 bear on one another and shed the load caused by the prestress. The thread segments 10A, 10B following the thread segment 15 have thread teeth with a different part flank angle γ. In the thread segment 10A assigned to the initial engagement region 14, the thread profile is determined according to the expected thermal or elastic expansions. In the thread segment 10B located between the thread segments 10A and 15, the thread profile is determined according to the expected thermal expansion. As already explained above with regard to FIGS. 3B and 4B, in the event of an increase in temperature (see FIG. 5B), the flanks 11 and 16 come into full engagement under elastic and/or thermal deformation, with the result that an equalization of the load-bearing behavior is obtained. In this case too, the flanks 11 and 16 in the thread segment 15 are relieved or lift off completely from one another.

It goes without saying that the embodiments described above and other possibilities for the configuration of the thread segments may be combined with one another, depending on requirements and choice of material. Depending on the design of the screw 13 and of the flange 12, thread segments 7, 9, 15 may be used with an unmodified profile, omitted or modified, as required, for the purpose of the shedding of load in the cold state.

The invention is distinguished by a thread which is manufactured in such a way that, at least at the intended application temperature and/or under the intended elastic load, it has a shape which brings about an equalized load-bearing behavior. This achieves a relief of the initial engagement region which is otherwise subjected to high load and which is critical for fatigue strength. Furthermore, the thread preferably has a thread segment of conventional type, which ensures an improved capacity for the transmission of the screw force in the cold state. An equalization of the load absorption and load distribution in the thread over the entire thread length and over an extended temperature range is thereby ensured.

1. A thread assembly for making a screw connection between a first component and a second component having mutually different elastic and/or thermal deformation behavior, comprising:
a thread, extending along a thread axis, formed in a first component with a thread structure for engagement into a counterthread of a second component formed with a counterthread structure;
said thread having a cylindrical thread segment of constant diameter; and
a further thread segment, axially adjacent said cylindrical thread segment, said further thread segment having a diameter varying along the thread axis for compensating for an anticipated elastic and/or thermal deformation under a predetermined the thermomechanical load.

2. The thread assembly according to claim 1, wherein the first component has a first material and the second component has a second material different from the first material.

3. The thread assembly according to claim 1, wherein the diameter increases monotonically along the thread axis in the further thread segment.

4. The thread assembly according to claim 3, wherein the diameter describes an enveloping curve having a tangent enclosing an acute angle with a line parallel to the thread axis, and the acute angle decreases monotonically.

5. The thread assembly according to claim 3, wherein the thread structure is, at least in one thread segment thereof, tapered with a taper angle that is acute relative to the thread axis.

6. The thread assembly according to claim 5, wherein said taper angle amounts to between 0.1° and 1.0°.

7. The thread assembly according to claim 5, wherein said taper angle amounts to approximately 0.3°.

8. The thread assembly according to claim 5, wherein said tapered thread segment is directly adjacent said cylindrical thread segment of constant diameter.

9. The thread assembly according to claim 1, wherein said thread is formed with at least one thread segment having a varied pitch along the thread axis.

10. The thread assembly according to claim 9, wherein said thread segment with the varied pitch is followed by a thread segment with constant pitch.

11. The thread assembly according to claim 1, wherein said thread is formed with at least one thread segment having a varied thread profile.

12. The thread assembly according to claim 11, wherein said thread is formed with flanks having a flank angle changing along the thread axis.

13. The thread assembly according to claim 11, wherein said thread is formed with a thread tooth having a falling flank and a rising flank, and said falling flank and said rising flank having mutually different flank angles.

14. The thread assembly according to claim 11, wherein said thread segment with the varying thread profile is followed by a thread segment having a constant thread profile.

15. The thread assembly according to claim 14, wherein said thread having the constant thread profile is a cylindrical thread segment.

16. The thread assembly according to claim 1, wherein said thread is one of a bolt thread and a nut thread.

17. The thread assembly according to claim 1, wherein said thread is laid out for use at an application temperature of above 500° C.

18. The thread assembly according to claim 1, wherein said thread is laid out for use at an application temperature of above 580° C.

19. The thread assembly according to claim 1, wherein said thread is a bolt thread formed on a screw composed of a material selected from the group consisting of nickel-based alloy, a cobalt-based alloy, and an austenitic steel.

20. A screw connection for a high application temperature, comprising a thread assembly according to claim 1 configured such that, when said thread and the counterthread mesh with one another at a normal temperature below the application temperature, an initial engagement region is relieved, and play remains at the initial engagement region between said thread structure and the counterthread structure.

21. In combination with a flange of a steam turbine, the thread assembly according to claim 1 configured for operation at a rated high application temperature of the steam turbine.

22. The screw connection according to claim 21, wherein the flange consists of a chromium steel having a chromium content of between 9% by weight and 12% by weight.
